(19) United States
(12) Patent Application Publication
(10) Pub. No.: US 2010/0095338 A1
(43) Pub. Date: Apr. 15, 2010

(54) CABLE MODEM AND METHOD FOR UPDATING DIGITAL CERTIFICATES OF THE CABLE MODEM

(75) Inventor: YEW-MIN LO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/430,102

(22) Filed: Apr. 26, 2009

(30) Foreign Application Priority Data
Oct. 14, 2008 (CN) 200810304921.1

(51) Int. Cl. H04N 7/173

(52) U.S. Cl. 725/111

(57) ABSTRACT

A method for updating digital certificates of a cable modem (CM) sends a request packet to a certificate authority if the CM needs to update a current digital certificate. A feedback packet responsive to the request packet is obtained from the certificate authority. A new digital certificate contained in the feedback packet is written into a storage system of the CM to replace the current digital certificate.

### BACKGROUND

1. Technical Field

Embodiments of the present disclosure relate to security of a cable television network, and particularly to a cable modem and method for updating digital certificates of the cable modem.

2. Description of Related Art

A cable modem is a device that allows high-speed access to the Internet via a cable television network. Since the cable television network is a shared medium, there are security risks to users as well as service providers. Unauthorized users may disguise themselves to obtain unauthorized services. Information transmitted over the cable television network may be hacked. Therefore, it is required to protect user data from malicious usage and prevent network services from attack. A digital certificate is issued to each cable modem to solve this problem. A cable modem terminal system may verify a cable modem according to the digital certificate.

Each digital certificate is characterized with a lifetime such as 20 years. An authorized user cannot make use of network services after the digital certificate expires. Therefore, the digital certificate of the cable modem has to be updated before the lifetime of the current digital certificate ends.

### BRIEF DESCRIPTION OF THE DRAWINGS

FIG. 1 is a block diagram of one embodiment of a system for updating digital certificates of a cable modem.

FIG. 2 is a block diagram of one embodiment of the cable modem of FIG. 1.

FIG. 3 including FIG. 3-1 and FIG. 3-2 is a flowchart of one embodiment of a method for updating digital certificates of a cable modem by implementing the system of FIG. 1.

### DETAILED DESCRIPTION

All of the processes described below may be embodied in, and fully automated via, functional code modules executed by one or more general purpose processors of a cable modem (CM). The code modules may be stored in any type of storage medium. Some or all of the methods may alternatively be embodied in specialized hardware.

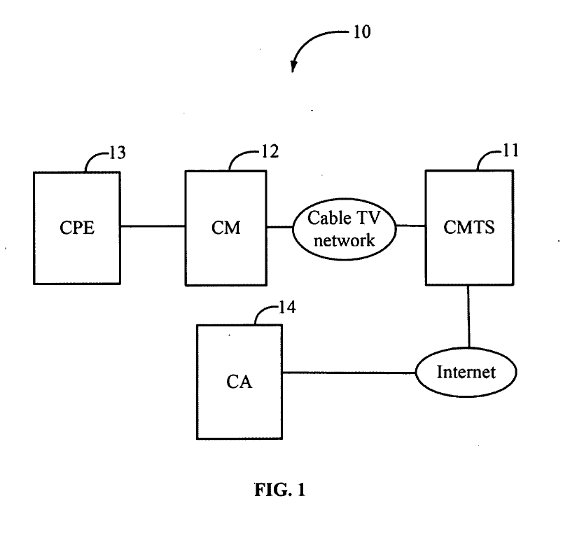

FIG. 1 is a block diagram of one embodiment of a system 10 for updating digital certificates of a CM 12. In one embodiment, the system 10 includes a cable modem terminal system (CMTS) 11, the CM 12, at least one customer premises equipment (CPE) 13 (only one shown in FIG. 1), and a certificate authority (CA) 14.

The CMTS 11 may be connected to the CM 12 over a cable television network. The CM 12 communicates with the Internet via the CMTS 11.

The CM 12 may be connected to the CPE 13 via an Ethernet interface or a universal serial bus (USB) interface, in one example. The CM 12 modulates an upstream radio-frequency signal to encode upstream digital information from the CPE 13, and sends the upstream radio-frequency signal to the CMTS 11. The CM 12 also demodulates a downstream radio-frequency signal from the CMTS 11 to decode downstream digital information, and sends the downstream digital information to the CPE 13. The CM 12 possesses a digital certificate for identification.

The CPE 13 is a terminal device such as a personal computer, a voice over internet protocol (VoIP) telephone, for example.

The CA 14 is connected to the CMTS 11 via the Internet. The CA 14 issues digital certificates to the CM 12.

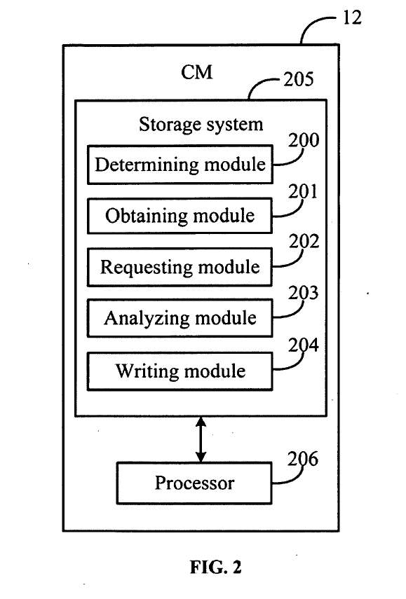

FIG. 2 is a block diagram of one embodiment of the CM 12 of FIG. 1. In one embodiment, the CM 12 includes a determining module 200, an obtaining module 201, a requesting module 202, an analyzing module 203, and a writing module 204. The CM 12 may comprise one or more processors, such as a processor 206 to execute the functional modules 200˜204. The CM 12 may further comprise a storage system 205. The storage system 205 stores the digital certificate and program instructions of the functional modules 200˜204. The storage system 205 may include one or more electronic memory devices, such as a random-access memory (RAM), a read-only memory (ROM), a programmable read-only memory (PROM), an electrically erasable programmable read-only memory (EEPROM), and a flash memory, for example.

The determining module 200 is operable to determine whether the CM 12 needs to update the current digital certificate with a new digital certificate. In one embodiment, the CM 12 needs to update the current digital certificate with a new digital certificate if a lifetime of the current digital certificate is less than a predetermined period (e.g. 10 years). In another embodiment, the CM 12 needs to update the current digital certificate with a new digital certificate if a remainder of the lifetime of the current digital certificate is less than another predetermined period (e.g. 2 years).

The obtaining module 201 is operable to obtain a public IP address. In the embodiment, the CM 12 is allocated a private IP address. The CM 12 cannot communicate with the CA 14 over the Internet using the private IP address. The obtained public IP address may be a destination IP address of a particular data packet that is sent to the CPE 13 and includes a source IP address that is a public IP address.

The requesting module 202 is operable to send request packets to the CA 14 if the CM 12 needs to update the current digital certificate with a new digital certificate. Each of the request packets may include a source IP address, a destination IP address, a source port number, a destination port number, a request packet identity, and a media access control (MAC) address. The source IP address is the obtained public IP address. The destination IP address is a public IP address of the CA 14. The source port number and the destination port number are two predetermined port numbers. For example, the source port number may be 29370 and the destination port number may be 53539. The CM 12 uses the request packet identity to mark the request packets. Therefore, the CA 14 may verify the request packets according to the request packet identity.

The analyzing module 203 is operable to obtain feedback packets from the CA 14 by analyzing packets received from the Internet. Each of the feedback packets may include a source IP address, a destination IP address, a source port number, a destination port number, a feedback packet identity, and a MAC address. Furthermore, the source IP address, the destination address, the source port number, and the destination port number of the feedback packet correspond to the destination IP address, the source IP address, the destination port number, and the source port number of the request packet respectively. The CA 14 uses the feedback packet identity to mark the feedback packets. Therefore, the CM 12 may identify the feedback packets according to the feedback packet identity.

The writing module 204 is operable to write the new digital certificate contained in the feedback packet into the storage system 205 to replace the current digital certificate. In one embodiment, the writing module 204 checks whether the new digital certificate is valid according to the predetermined period. The new digital certificate is valid if a lifetime of the new digital certificate is equal to or greater than the predetermined period. Otherwise, the new digital certificate is invalid if the new digital certificate is less than the predetermined period. The feedback packet is dropped when the new digital certificate is invalid. The new digital certificate goes into effect after the CM 12 is restarted.

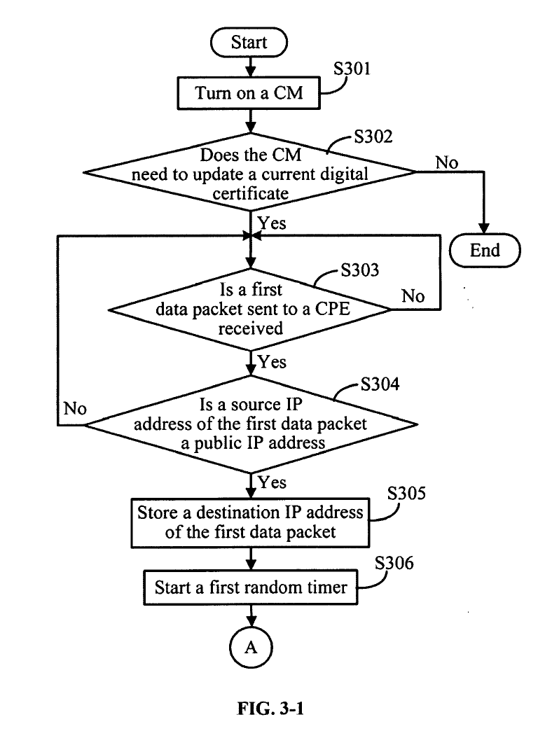

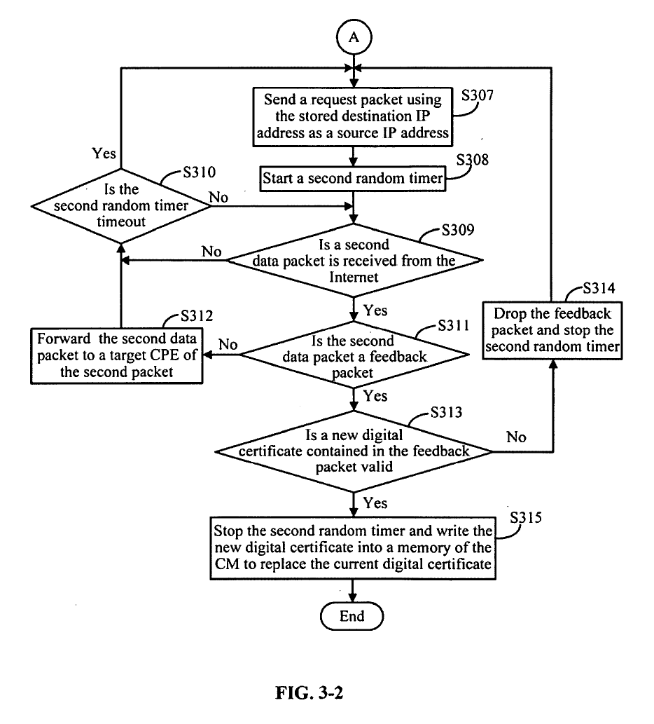

FIG. 3 including FIG. 3-1 and FIG. 3-2 is a flowchart of one embodiment of a method for updating digital certificates of the CM 12 by implementing the system 10 of FIG. 1. Depending on the embodiment, additional blocks may be added, others removed, and the ordering of the blocks may be changed.

In block S301, the CM 12 is turned on.

In block S302, the determining module 200 determines whether the CM 12 needs to update the current digital certificate with a new digital certificate. In one embodiment, the CM 12 needs to update the current digital certificate with a new digital certificate if a lifetime of the current digital certificate is less than a predetermined period. For example, the CM 12 needs to update the current digital certificate of the CM 12 with a new digital certificate if the lifetime of the current digital certificate is ten years and the predetermined period is fifteen years. In another embodiment, the CM 12 needs to update the current digital certificate with a new digital certificate if a remainder of the lifetime of the current digital certificate is less than another predetermined period. If the CM 12 does not need to update the current digital certificate with a new digital certificate, the procedure ends.

Otherwise, if the CM 12 needs to update the current digital certificate with a new digital certificate, in block 303, the obtaining module 201 checks whether a first data packet sent to the CPE 13 is received from the Internet.

If the first data packet is received, in block S304, the obtaining module 201 determines whether a source IP address of the first data packet is a public IP address. The procedure may move to block S303 if the source IP address of the first data packet is not a public IP address.

Otherwise, if the source IP address of the first data packet is a public IP address, in block S305, the obtaining module 201 stores a destination IP address of the first data packet into the storage system 205.

In block S306, the requesting module 202 starts a first random timer. In one embodiment, a first random delay generated by the first random timer may be 0-10 minutes.

In block S307, the requesting module 202 sends a request packet to the CA 14 via the CMTS 11 using the stored destination IP address as a source IP address when the first random timer is timeout. In one embodiment, the request packet includes a source IP address, a destination IP address, a source port number, a destination port number, a request packet identity, and a media access control (MAC) address. The source IP address of the request packet is the stored destination IP address. The destination IP address is a public IP address of the CA 14. The source port number and the destination port number are two predetermined port numbers. For example, the source port number is 29370 and the destination port number is 53539. The CM 12 uses the request packet identity, such as 0x97687654, to mark the request packets.

In block S308, the analyzing module 203 starts a second random timer. In one embodiment, a second random delay generated by the second random timer may be 0-10 minutes.

In block S309, the analyzing module 203 checks if a second data packet is received from the Internet. If the second data packet is received from the Internet, the procedure may move to block S311. Otherwise, if the second data packet is not received from the Internet, the procedure may move to block S310.

In block S310, the analyzing module 203 determines whether the second random timer is timeout. If the second random timer is timeout, the procedure may return to S307. Otherwise, if the second random timer is not timeout, the procedure may return to S309.

In block S311, the analyzing module 203 determines whether the second data packet is a feedback packet responsive to the request packet. A feedback packet may include a source IP address, a destination IP address, a source port number, a destination port number, a feedback packet identity, and a MAC address. Furthermore, the source IP address, the destination address, the source port number, and the destination port number of the feedback packet correspond to the destination IP address, the source IP address, the destination port number, and the source port number of the request packet respectively. For example, the source port number and the destination port number of the request packet are 29370 and 53539 respectively. Therefore, the source port number and the destination port number of the feedback packet should be 53539 and 29370 respectively. The feedback packet identity, such as 0x75493023, is used by the CA 14 to mark the feedback packet. The analyzing module 203 verifies the second data packet according to the source IP address, the destination address, the source port number, the destination port number and the feedback packet identity of the feedback packet.

If the second data packet is not the feedback packet, in block S312, the analyzing module 203 forwards the second data packet to a target CPE, such as the CPE 13, and the procedure may move to block S310.

Otherwise, if the second data packet is the feedback packet, in block S313, the writing module 204 checks whether a new digital certificate contained in the feedback packet is valid. In one embodiment, the writing module 204 checks whether the new digital certificate is valid according to the predetermined period. The new digital certificate is valid if a lifetime of the new digital certificate is equal to or greater than the predetermined period. Otherwise, the new digital certificate is invalid if the new digital certificate is less than the predetermined period.

If the new digital certificate is invalid, in block S314, the writing module 204 drops the feedback packet, the second random timer is stopped, and the procedure returns to block S307.

Otherwise, if the new digital certificate is valid, in block S315, the writing module 204 stops the second random timer and writes the new digital certificate into the storage system 205 to replace the current digital certificate. In one embodiment, the new digital certificate is written in a flash memory of the storage system 205. The new digital certificate goes into effect after the CM 12 is restarted.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A cable modem (CM), comprising:
at least one processor operable to execute program instructions, and
a storage system operable to store program instructions executable by the at least one processor, for performing steps of:
determining if the CM needs to update a current digital certificate of the CM;
sending at least one request packet to a certificate authority (CA) that issues digital certificates upon the condition that the CM needs to update the current digital certificate;
obtaining at least one feedback packet responsive to the request packet from the CA; and
writing a new digital certificate contained in the feedback packet into the storage system to replace the current digital certificate.

2. The CM of claim 1, further comprising a step of obtaining a public IP address that acts as a source IP address of each of the at least one request packet.

3. The CM of claim 2, wherein the obtained public IP address is a destination IP address of a particular data packet that is sent to a customer premises equipment connected to the CM and comprises a source IP address that is a public IP address.

4. The CM of claim 1, wherein each of the at least one request packet comprises a request packet identity, the request packet identity used by the CM to mark the request packet and for the CA to identify the request packet.

5. The CM of claim 1, wherein each of the at least one feedback packet comprises a feedback packet identity, the feedback packet identity used by the CA to mark the feedback packet and for the CM to identify the feedback packet.

6. A method for updating digital certificates of a cable modem (CM), the method comprising:
determining if the CM needs to update a current digital certificate;
sending at least one request packet to a certificate authority (CA) that issues digital certificates upon the condition that the CM needs to update the current digital certificate;
obtaining at least one feedback packet responsive to the request packet from the CA; and
writing a new digital certificate contained in the feedback packet into a storage system of the CM to replace the current digital certificate.

7. The method of claim 6, further comprises obtaining a public IP address that acts as a source IP address of each of the at least one request packet.

8. The method of claim 7, wherein the obtained public IP address is a destination IP address of a particular data packet that is sent to a customer premises equipment connected to the CM and comprises a source IP address that is a public IP address.

9. The method of claim 6, wherein each of the at least one request packet comprises a request packet identity, the request packet identity used by the CM to mark the request packet and for the CA to identify the request packet.

10. The method of claim 6, wherein each of the at least one feedback packet comprises a feedback packet identity, the feedback packet identity used by the CA to mark the feedback packet and for the CM to identify the feedback packet.

11. A storage medium having stored thereon instructions that, when executed by a cable modem (CM), cause the CM to execute a method for updating digital certificates of the CM, the method comprising:
determining if the CM needs to update a current digital certificate;
sending at least one request packet to a certificate authority (CA) that issues digital certificates upon the condition that the CM needs to update the current digital certificate;
obtaining at least one feedback packet responsive to the request packet from the CA; and
writing a new digital certificate contained in the feedback packet into a storage system of the CM to replace the current digital certificate.

12. The medium of claim 11, wherein the method further comprises obtaining a public IP address, the obtained public IP address acting as a source IP address of each of the at least one request packet.

13. The medium of claim 12, wherein the obtained public IP address is a destination IP address of a particular data packet that is sent to a customer premises equipment connected to the CM and comprises a source IP address that is a public IP address.

14. The medium of claim 11, wherein each of the at least one request packet includes a request packet identity, the request packet identity used by the CM to mark the request packet and for the CA to identify the request packet.

15. The medium of claim 11, wherein each of the at least one feedback packet includes a feedback packet identity, the feedback packet identity used by the CA to mark the feedback packet and for the CM to identify the feedback packet.
